(19) United States
(12) Patent Application Publication
(10) Pub. No.: US 2012/0173553 A1
(43) Pub. Date: Jul. 5, 2012

(54) SYSTEMS AND METHODS FOR ATTRIBUTE-BASED SEARCH FILTERING

(75) Inventors: Johan Johansson, San Jose, CA (US); Sashanka Vishnuvajhala, San Jose, CA (US); Ayon Sinha, Sunnyvale, CA (US); Hugh Evan Williams, Saratoga, CA (US)

(73) Assignee: eBay Inc., San Jose, CA (US)

(21) Appl. No.: 12/983,760

(22) Filed: Jan. 3, 2011

(51) Int. Cl. G06F 17/30

(52) U.S. Cl. 707/754; 707/E17.014

(57) ABSTRACT

A method and a system filter search results according to attributes of current results. A plurality of content elements is tagged so each content element is associated with a plurality of tags. Each tag describes an attribute of at least one of the plurality of content elements. A first listing of results is provided to a user. Each of the results in the first listing includes a content element and the plurality of tags associated with the content element. A first selection of a first tag in a first result of the first listing received from a user. A second selection of a second tag is received from the user. The second tag may be in the first result or in a second result of the first listing of results. A second listing of results is provided to the user where each of the results of the second listing includes at least the first tag and the second tag.

### TECHNICAL FIELD

The present application relates generally to the technical field of data management and, in one specific example, to systems and methods for attribute-based search filtering.

### BACKGROUND

Using the Internet, users are able to search for and view many pieces of information relating to keywords. In some instances, a user may view a webpage about, for example, a particular movie. The webpage may include a link displayed as, for example, an actor's name in the description of the movie. Upon selecting the link having the actor's name, the user is re-directed to another webpage that includes, for example, a biography of the actor and a list of links to movies in which the actor has performed.

Using some websites, an interface may include a list of metatags that describe attributes of, for example, items for sale. The metatags may be selected by the user to narrow a list of search results. In some instances, the metatags are grouped according to type (e.g., size, color, style, etc.) where the user is limited to choosing one metatag of some types.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one or more embodiments may be deployed.

FIG. 2 is a block diagram of a search filter, according to some embodiments.

FIG. 3 is a flowchart of an example process for attribute-based search filtering, according to some embodiments.

FIG. 4 is a high-level entity-relationship diagram, illustrating various tables that may be maintained within various databases, according to some embodiments.

FIGS. 5-7 depict example user interfaces, according to some embodiments.

FIG. 8 shows a diagrammatic representation of machine in the example form of a computer system within which a set of instructions, for causing the machine to perform any one or more of the methodologies discussed herein, may be executed.

### DETAILED DESCRIPTION

Example methods and systems to filter results based on attributes are described. In the following description, for purposes of explanation, numerous specific details are set forth in order to provide a thorough understanding of example embodiments. It will be evident, however, to one skilled in the art that the present invention may be practiced without these specific details.

While browsing the Internet (or other search-based system such as a local area network (LAN), a wide-area network (WAN), or the like), a user may view a content element. A content element is a description of a person, place, or thing. For example, a content element may be, but is not limited to, a description of an actor, a movie, a song, an album, a musician, a city, an item for sale or lease, a service or service provider, a video game, a writer, a book, a blog, a newspaper, a television show, etc. Each content element identified by an attribute-based search filter is associated with one or more tags. Each tag is used to label the content element as having a particular attribute. An attribute is a characteristic of the content element and may include, but is not limited to, genre, category, contributor(s), size, color, style, gaming console, format, operating system, etc.

When a user browses to a website having the content element, the content element is displayed as part of a result. The result includes the content element and the tags associated with the content element. The tags may be organized according to type. The type of the tag is used to classify the attribute described by the tag. For example, types of tags associated with movies may include, but are not limited to, “genre,” “director,” and “stars.”

A selection received from the user indicating one or more tags is received via an interface. In response, the attribute-based search filter provides a list of results including content elements that are associated with all of the indicated tags. The user may select an additional tag in one of the results and the results are filtered to include those that are also associated with the additional tag. The user may also deselect one or more of the selected tags and the results are modified to include additional results not associated with the deselected tag.

A method and a system filter search results according to attributes of current results. A plurality of content elements is tagged so each content element is associated with a plurality of tags. Each tag describes an attribute of at least one of the plurality of content elements. A first listing of results is provided to a user. Each of the results in the first listing includes a content element and the plurality of tags associated with the content element. A first selection of a first tag in a first result of the first listing received from a user. A second selection of a second tag is received from the user. The second tag may be in the first result or in a second result of the first listing of results. A second listing of results is provided to the user where each of the results of the second listing includes at least the first tag and the second tag.

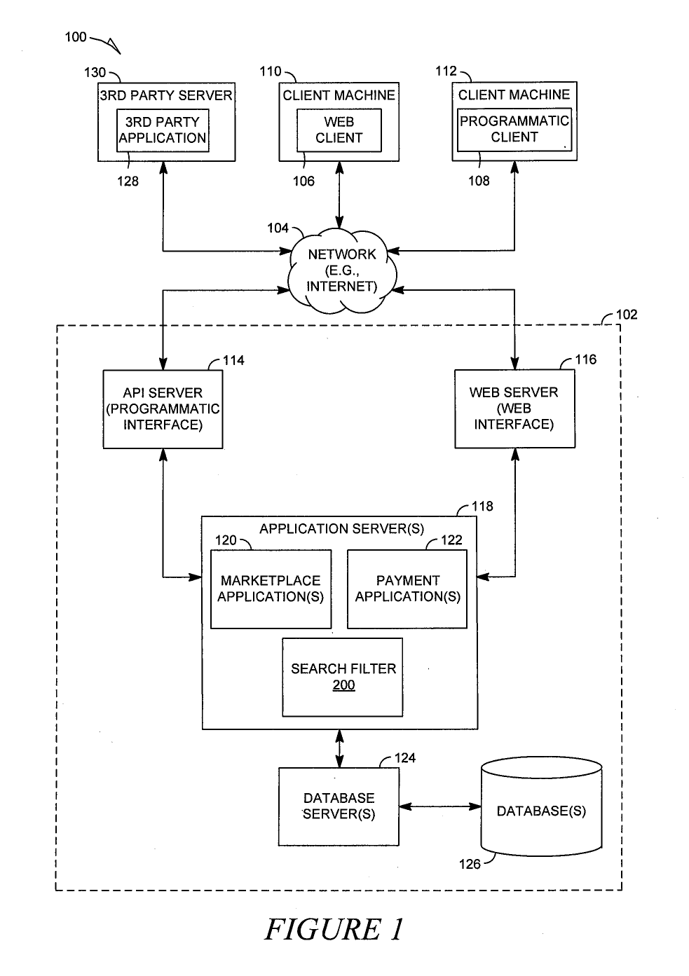

FIG. 1 is a network diagram depicting a client-server system 100, within which one or more example embodiments may be deployed. A networked system 102, in the example form of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer® browser developed by Microsoft® Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120, payment applications 122, and a search filter 200. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. The search filter 200 may provide an attribute-based search filter. While the marketplace applications 120, the payment applications 122 and the search filter 200 are shown in FIG. 1 to form part of the networked system 102, it will be appreciated that, in alternative embodiments, the payment applications 122 or the search filter 200 may be separate and distinct from the networked system 102.

Further, while the client-server system 100 shown in FIG. 1 employs a client-server architecture, the present invention is of course not limited to such an architecture, and could equally well find application in a distributed, or peer-to-peer, architecture system, for example. Various ones of the marketplace applications 120 and the payment applications 122 could also be implemented as standalone software programs, which do not necessarily have networking capabilities.

The web client 106 accesses the various one of the marketplace applications 120 and the payment applications 122 via the web interface supported by the web server 116. Similarly, the programmatic client 108 accesses the various services and functions provided by the marketplace applications 120 and the payment applications 122 via the programmatic interface provided by the API server 114. The programmatic client 108 may, for example, be a seller application (e.g., the TurboLister application developed by eBay® Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

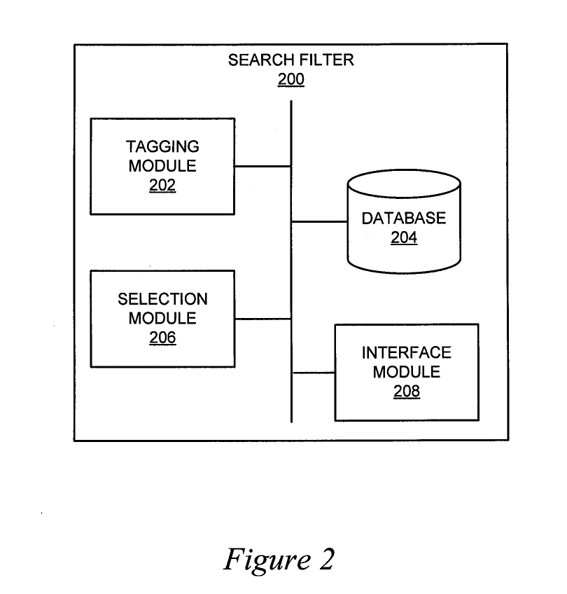

FIG. 2 is a block diagram of a search filter 200, according to some embodiments. The search filter 200 is implemented in one or more hardware modules or software modules. The software modules may be executed from a non-transitory computer-readable medium or from a non-transitory machine-readable medium, described in more detail below.

A tagging module 202 is to tag content elements so each content element is associated with a plurality of tags. Each of the tags describes an attribute of the content element. A content element associated with the one or more tags is referred to as a result. The content elements may be identified based on an existing database of content elements such as a movie database, a videogame database, a product database, or another database of content elements.

The tags associated with each content element may include tags previously associated with the content elements in the database. Additional tags may be associated with each content element based on, for example, text included in the content element, user-provided tags, and the like.

The tagging module 202 may assign, or access an assignment of, a type to the respective tags of the plurality of tags. Tags may be grouped by type and sub-type. For example, sub-types “director” and “stars” may belong to a broader type, “contributors.” The tags may be selected based on a category of the content element. For example, the above tags may be associated with the category “movies.” Tags associated with the category “clothing” may include the types “size,” “style,” “color,” and the like.

The tagging module 202 may access a database 204 to store the tags associated with each content element. The database 204 may store the content elements or the tags associated with each content element. In the database 204, the tags may each be associated with one or more tag types.

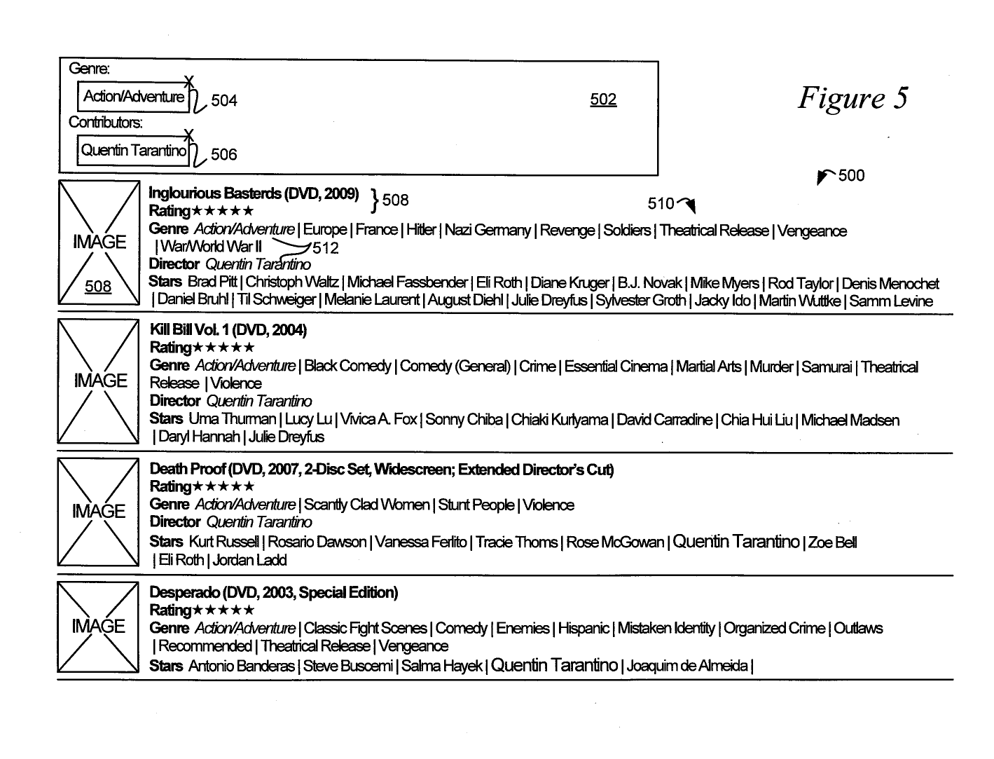

A content element may be displayed along with its tags as a result. The display may or may not be provided by an interface module 208. In some instances, the content element may be displayed in an interface not generated by the interface module 208, for example, the result may be included in a list of search results, a list of recommendations made to a user, a list of popular results, a product detail page, or some other display of results that is not generated by the interface module 208. A selection module 206 is arranged to receive a selection of a first tag included in a first result displayed in an interface displayed to a user. The first interface includes a first listing of results. The first listing includes one or more results. Each respective result includes a content element and the tags associated with the content element to describe the content element. The tag may be displayed as a link. See, e.g., FIGS. 5-7.

The selection module 206 is further arranged to receive one or more additional selections of additional tags. The selected additional tags may be included in the same result as the first selected tag or included in one or more additional results that describe other content elements. Upon receiving the selections, the selection module 206 determines which content elements in the database 204 are associated with the selected tags.

The interface module 208 is arranged to provide an interface to the user upon receiving the selection. The interface includes a second listing of results, where each of the results includes at least the selected tags. The interface provided by the interface module 208 may include an indication of the first tag and the second tag.

In operation, the selection module 206 may receive a further selection of further tags via the interface provided by the interface module. In this instance, the interface module 208 provides a further interface to the user, where the further interface includes further results that include at least previously selected tags and the further tags. This process may be repeated one or more times if the user selects further tags in subsequent interfaces.

In another instance, the selection module 206 may receive a selection or de-selection of a previously-selected tag via an interface provided by the interface module 208. Consequently, the interface module 208 may provide another interface that includes another listing of results that includes content elements associated with previously selected tags but not necessarily including the de-selected tag.

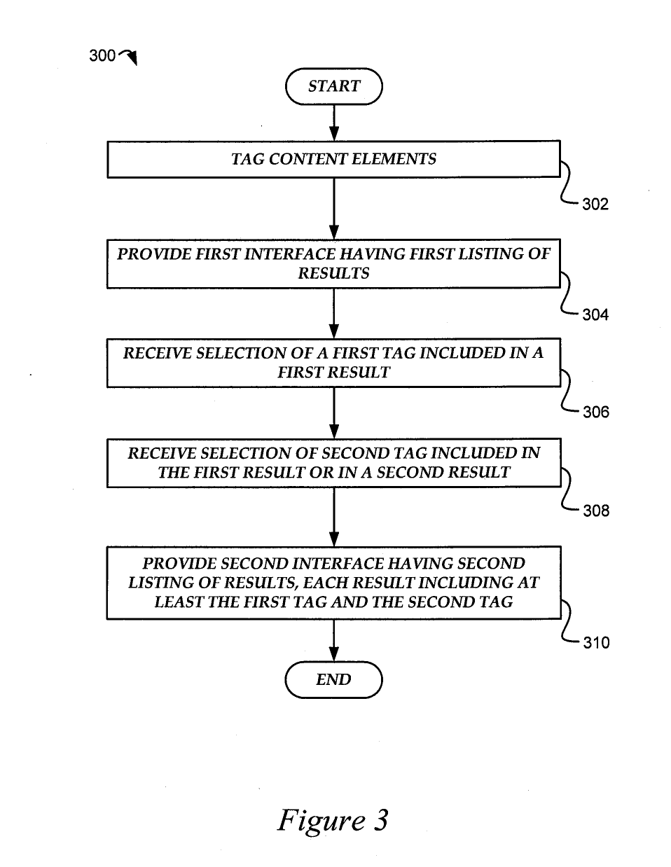

FIG. 3 is a flowchart of an example process 300 for attribute-based search filtering, according to some embodiments. The process 300 may be performed by the search filter 200 or by another filter.

In an operation 302, the content elements are tagged by, for example, the tagging module 202. The content elements are tagged so that each content element is associated with a plurality of tags, and each of the tags is used to describe an attribute of the content element.

In an operation 304, a first interface is provided to a user. The first interface may be generated by the interface module 208 or by a marketplace application 120 (see FIG. 1) in communication with the search filter 200. The first interface includes a first listing of results. Within the first listing, the respective results including a content element and the plurality of tags to describe the content element.

In an operation 306, a selection of a first tag in a first result is received. The first tag may be associated with a first type. In some instances, an interface is provided to the user upon receiving the selection of the first tag. The interface includes a listing of results that each includes the first tag.

In an operation 308, a selection of a second tag in the first result or in another result is received by, for example, the selection module 206. The second tag may be associated with the first type or may be assigned a second type.

In an operation 310, a second interface is provided to the user by, for example, the interface module 208. The second interface includes a second listing of results that each includes at least the first tag and the second tag. The second interface may further include an indication of the first tag and the second tag.

Operations 308 and 310 may be repeated one or more times as additional selections of further tags are received. The resulting interfaces include results that are associated with each of the selected tags. Further, if a selected tag is selected again or is de-selected, the resulting interface may include results that include at least the remaining tags.

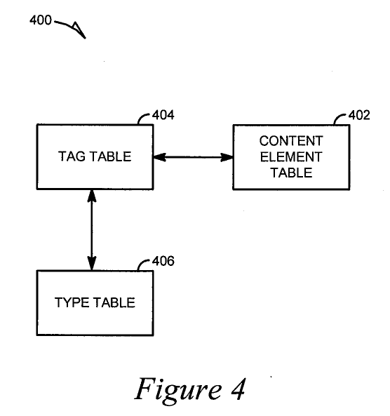

FIG. 4 is a high-level entity-relationship diagram 400, illustrating various tables that may be maintained within the database 204, according to some embodiments. A content element table 402 contains a record of the content elements. The content element table 402 may include a record, or a pointer to, one or more tags, tag types, or categories associated with each content element.

A tag table 404 contains a record of each tag that can be associated with one or more content elements. The tag table 404 may include a record of the content elements associated with each tag. The tag table 404 may additionally include a tag type associated with each tag for one or more categories. A type table 406 contains a record of each type of tag and, optionally, one or more categories associated with each type.

FIGS. 5-7 depict example user interfaces, according to some embodiments. The user interfaces may be provided by the interface module 208.

Referring to FIG. 5, the example user interface comprises a listing of results 500 and an indication of selected tags 502. The indication of selected tags 502 includes two selected tags in the category “movies”: a genre tag 504, labeled in FIG. 5 as “Action/Adventure,” and a contributors tag 506, labeled as “Quentin Tarantino.” The genre tag 504 is provided as part of the type, “genre,” and the contributors tag 506 is provided as part of the type, “contributors.” The tags 504 and 506 may be de-selected by clicking on the “x” in the upper right corner of the tags.

The listing of results 500 comprises a plurality of results. The results each include a content element comprising a description 508. The description 508 includes, for example, an image, a title, and a rating. Each result further includes one or more additional tags 510, optionally organized by type. Selected tags 512 are displayed italicized to indicate that they are already selected.

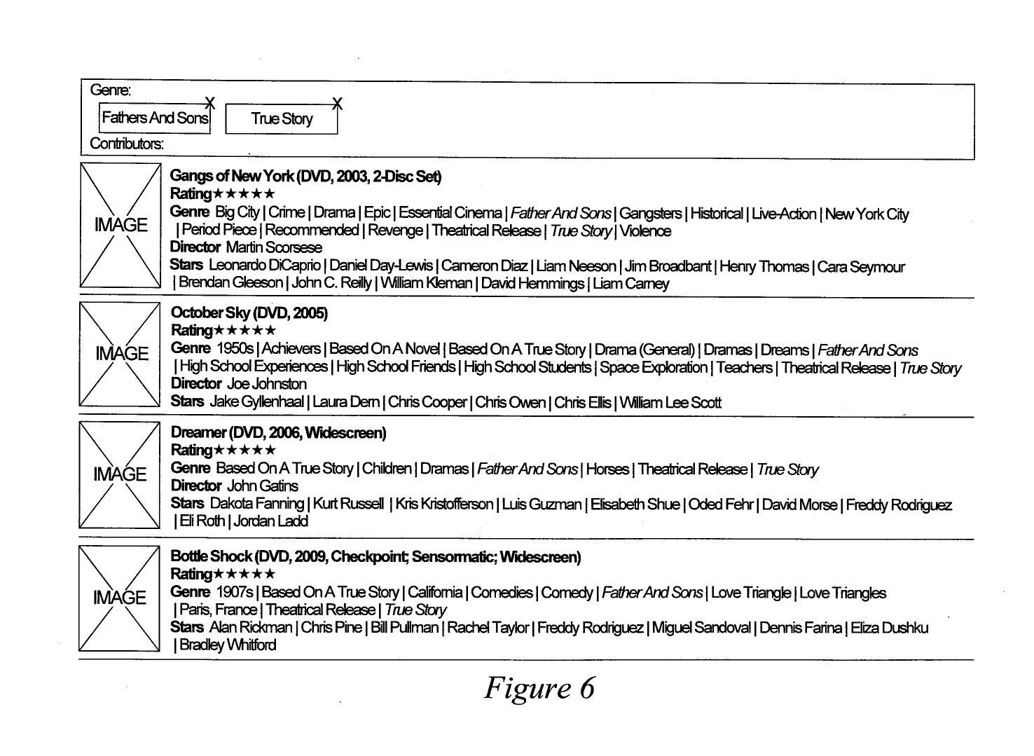

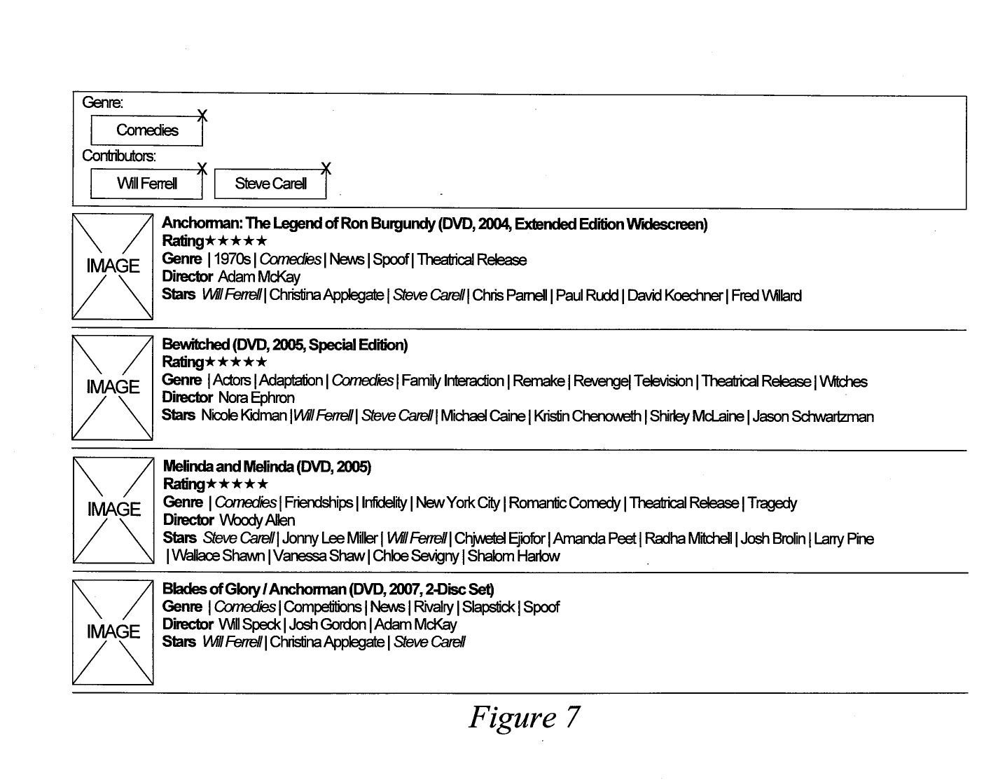

FIGS. 6 and 7 include additional sample user interfaces. The interface shown in FIG. 6 shows two tags (“Fathers and Sons” and “True Story”) of the same type (“Genre”) selected. The interface of FIG. 7 shows three tags selected where one tag (“Comedies”) is of a first type (“Genre”) and where the second tag (“Will Farrell”) and third tag (“Steve Carell”) are of a second type (“Contributors”).

FIGS. 5-7 show interfaces that do not include a list of unselected metatags separate from the results. Instead, the tags shown separate from the results are previously selected by the user. In the embodiments of FIGS. 5-7, the user is not able to select tags that do not appear within the shown results. The user may be limited to selecting tags associated with the content elements that are displayed to the user.

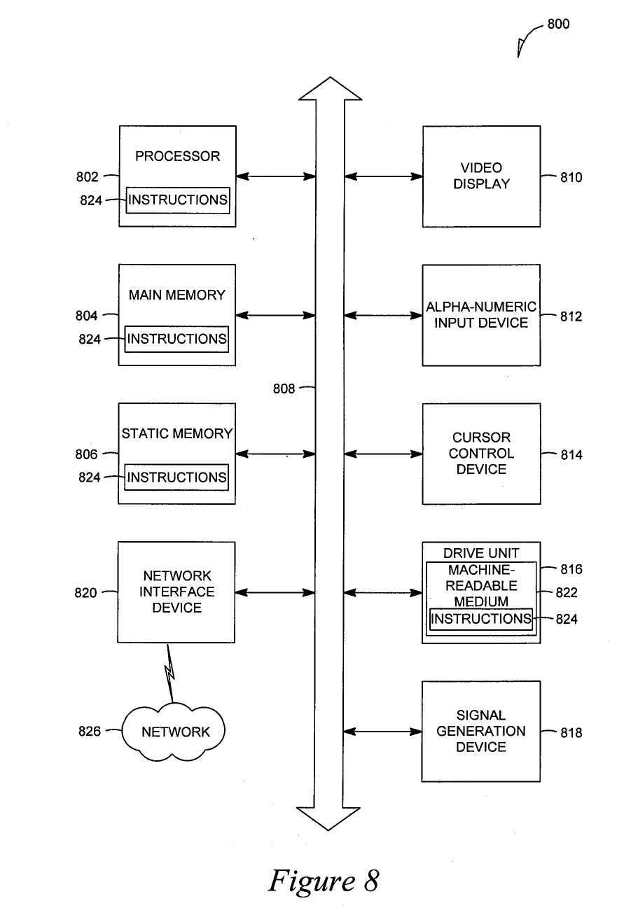

FIG. 8 shows a diagrammatic representation of machine in the example form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes one or more processors 802 (e.g., a central processing unit (CPU) a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820. The computer system 800 may further include a touchscreen (not depicted).

The disk drive unit 816 includes a non-transitory machine-readable medium 822 on which is stored one or more sets of instructions 824 (e.g., software) embodying any one or more of the methodologies or functions described herein. The software 824 may also reside, completely or at least partially, within the main memory 804 and/or within the one or more processors 802 during execution thereof by the computer system 800, the main memory 804 and the one or more processors 802 also constituting machine-readable media.

The software 824 may further be transmitted or received over a network 826 via the network interface device 820.

While the non-transitory machine-readable medium 822 is shown in an example embodiment to be a single medium, the term “non-transitory machine-readable medium” should be taken to include a single medium or multiple media (e.g., a centralized or distributed database, and/or associated caches and servers) that store the one or more sets of instructions. The term “non-transitory machine-readable medium” shall also be taken to include any medium that is capable of storing, encoding or carrying a set of instructions for execution by the machine and that cause the machine to perform any one or more of the methodologies of the present invention. The term “non-transitory machine-readable medium” shall accordingly be taken to include, but not be limited to, solid-state memories, and optical and magnetic media.

Thus, a method and system for attribute-based search filtering have been described. Some embodiments discussed herein may provide technical solutions based on providing a more efficient searching experience, resulting in fewer database look-ups or reduced consumption query processing resources. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A method comprising:
tagging a plurality of content elements so each of the plurality of content elements is associated with a plurality of tags, each of the plurality of tags to describe an attribute associated with at least one of the plurality of content elements;
providing a first listing of results, each result of the first listing of results including a content element of the plurality of content elements and the plurality of tags to describe the content element;
receiving a first selection of a first tag in a first result of the first listing of results;
receiving a second selection of a second tag, the second tag being in the first result or a second result of the first listing of results; and
using one or more processors, providing a second listing of results, each result of the second listing of results including at least the first tag and the second tag.

2. The method of claim 1, wherein the respective tags of the plurality of tags are assigned a type.

3. The method of claim 2, wherein the first tag is assigned a first type and the second tag is assigned a second type.

4. The method of claim 2, wherein the first tag is assigned a first type and the second tag is assigned the first type.

5. The method of claim 1, wherein a second interface to display the second listing includes an indication of the first tag and the second tag.

6. The method of claim 1, further comprising:
receiving a third selection of a third tag via the second interface; and
providing a third listing of results, the respective results of the third listing including at least the first tag, the second tag, and the third tag.

7. The method of claim 6, further comprising:
receiving a deselection of the first tag in the third user interface; and
providing a fourth listing of results, the respective results of the fourth listing including at least the second tag and the third tag but not including the first tag.

8. The method of claim 1, further comprising:
providing a third listing to the user upon receiving the first selection of the first tag in the first result, each result of the third listing including the first tag.

9. The method of claim 1, wherein the plurality of content elements are selected from the group consisting of movies, books, songs, and videogames.

10. A system comprising:
a tagging module, having one or more processors, to tag a plurality of content elements so each of the plurality of content elements is associated with a plurality of tags, each of the plurality of tags to describe an attribute associated with at least one of the plurality of content elements;
a selection module to receive a first selection of a first tag displayed in a first listing of results, each result of the first listing of results including a content element of the plurality of content elements and the plurality of tags to describe the content element, the first tag included in a first result of the first listing results and to receive a second selection of a second tag, the second tag being in the first result or a second result of the first listing of results; and
an interface module to provide a second listing of results, the respective results of the second listing of results including at least the first tag and the second tag.

11. The system of claim 10, wherein the tagging module is further to assign a type to the respective tags of the plurality of tags.

12. The system of claim 11, wherein the selection module is further to determine that the first tag is assigned a first type and that the second tag is assigned a second type.

13. The system of claim 11, wherein the selection module is further to determine that the first tag is assigned a first type and that the second tag is assigned the first type.

14. The system of claim 10, wherein the interface module is further to provide second interface to display the second listing and an indication of the first tag and the second tag.

15. The system of claim 10, wherein the selection module is further to receive a third selection of a third tag via the second listing of results and the interface module is further to provide a third listing of results to the user, the respective results of the third listing of results including at least the first tag, the second tag, and the third tag.

16. The system of claim 15, wherein the selection module is further to receive a deselection of the first tag and the interface module is further to provide a fourth listing of results, the respective results of the fourth listing including at least the second tag and the third tag but not including the first tag.

17. The system of claim 10, wherein the interface module is further to provide a third listing to the user upon receipt of the first selection of the first tag in the first result, each result of the third listing including the first tag.

18. The system of claim 10, wherein the plurality of content elements are selected from the group consisting of movies, books, songs, and videogames.

19. A non-transitory computer-readable medium having instructions embodied thereon, the instructions being executable by one or more processors to perform a method of attribute-based search filtering, the method comprising:
tagging a plurality of content elements so each of the plurality of content elements is associated with a plurality of tags, each of the plurality of tags to describe an attribute associated with at least one of the plurality of content elements;
providing a first listing of results, each result of the first listing of results including a content element of the plurality of content elements and the plurality of tags to describe the content element;
receiving a first selection of a first tag in a first result of the first listing of results;
receiving a second selection of a second tag, the second tag being in the first result or a second result of the first listing of results; and
using the one or more processors, providing a second listing of results, the second listing of results including at least the first tag and the second tag.

20. The non-transitory computer-readable medium of claim 19, wherein a second interface to display the second listing further includes an indication of the first tag and the second tag.
